(19) United States
(12) Patent Application Publication
(10) Pub. No.: US 2019/0114543 A1
(43) Pub. Date: Apr. 18, 2019

(54) LOCAL LEARNING SYSTEM IN ARTIFICIAL INTELLIGENCE DEVICE

(71) Applicant: British Cayman Islands Intelligo Technology Inc., Hsinchu County (TW)

(72) Inventors: Chun-Hung CHEN, Taichung City (TW); Chen-Chu HSU, Taipei City (TW); Tsung-Liang CHEN, Hsinchu County (TW)

(21) Appl. No.: 16/147,939

(22) Filed: Oct. 1, 2018

Related U.S. Application Data
(60) Provisional application No. 62/571,293, filed on Oct. 12, 2017.
(60) Provisional application No. 62/590,379, filed on Nov. 24, 2017.

(51) Int. Cl. G06N 3/08

(52) U.S. Cl. CPC G06N 3/08

(57) ABSTRACT

A local learning system in a local artificial intelligence (AI) device includes at least one data source, a data collector, a training data generator, and a local leaning engine. The data collector is connected to the at least one data source, and used to collect training data. The training data generator is connected to the data collector, and used to analyze the training data to produce paired examples for supervised learning, or unlabeled data for unsupervised learning. The local leaning engine is connected to the training data generator, and includes a local neural network. The local neural network is trained by the paired examples or the unlabeled data in a training phase, and makes inference in an inference phase.

### CROSS REFERENCE TO RELATED APPLICATION

This application claims the benefit of filing date of U. S. Provisional. Application Ser. No. 62/571,293, entitled “Local Learning for Artificial Intelligence Device” filed Oct. 12, 2017 under 35 USC § 119(e)(1).

This application claims the benefit of filing date of U. S. Provisional Application Ser. No. 62/590,379, entitled “Neural Network Online Pruning” filed Nov. 24, 2017 under 35 USC § 119(e)(1).

### BACKGROUND OF THE INVENTION

### 1. Field of the Invention

The present invention relates to machine learning and, more particularly, to a local learning system for artificial intelligence devices.

### 2. Description of Related Art

Generally, a deep neural network workflow includes two phases: a training phase and an inference phase. In the training phase, the deep neural network is trained to understand the natures of objects or the conditions of situations. In the inference phase, the deep neural network identifies (real-world) objects or situations for making an appropriate decision or prediction.

A deep neural network is typically trained on a computing server with multiple graphics processing unit (GPU) cards. The training takes a long period of time, ranging from hours to weeks, or even longer.

FIG. 1 shows a schematic diagram illustrating a prior art deep neural network architecture between a standalone or cloud computing server 11 (simply called “the server 11”) and a local device 12. The server 11 includes a deep neural network, and the training is performed on the server 11 end. A local device 12 has to download the trained model from the server 11 via a network link 13, and then the local device 12 can perform the inference based on the trained model.

In the prior art case, the local device 12 is incapable of the training. Moreover, the deep neural network designed for the server 11 is not applicable to the local device 12, because the local device 12 only has limited capacity. In other words, a direct system migration is impractical.

Therefore, it is desirable to provide a local learning system.

### SUMMARY OF THE INVENTION

One object of the present invention is to provide a local learning system applicable to various types of local AI devices. Each individual local AI device can adapt to its environment by local learning with local (sensor) data.

In order to achieve the object, the present invention provides a local learning system in a local artificial intelligence (AI) device, including at least one data source, a data collector, a training data generator, and a local leaning engine. The data collector is connected to the at least one data source, and used to collect input data. The training data generator is connected to the data collector, and used to analyze the input data to produce paired examples for supervised learning, or unlabeled data for unsupervised learning. The local leaning engine is connected to the training data generator, and includes a local neural network. The local neural network is trained by the paired examples or the unlabeled data in a training phase, and makes inference in an inference phase.

Preferably, the local learning system is trained in the local AI device without connection to a standalone or cloud computing server with high level hardware.

Preferably, the local leaning engine allows inputting a single training data point in sequence or a small batch of data points in parallel.

Preferably, the local leaning engine employs an incremental leaning mechanism.

Preferably, the local leaning engine is designed in a way that the inference phase is not interrupted during the training phase.

Preferably, the local AI device is a smartphone, the at least one data source includes a primary microphone and a secondary microphone, and the training data generator produces data pairs from at least one of the primary microphone or the secondary microphone. Moreover, the data pairs imply a clean sound and a noisy sound. Furthermore, the local leaning engine is trained by stochastic gradient descent with the data pairs, so as to perform sound enhancement by identifying and further filtering out undesirable noises from the noisy sound.

Another object of the present invention is to introduce a pruning method to reduce the complexity of neural network, allowing a pruned neural network executable by the local AI device.

In order to achieve the other object, the present invention provides a local learning system in a local artificial intelligence (AI) device, including at least one data source, a data collector, a data generator, and a local engine. The data collector is connected to the at least one data source, and used to collect input data. The data generator is connected to the data collector, and used to analyze the input data. The local engine is connected to the data generator, and including a local neural network, wherein the local neural network is a pruned neural network that some neurons or some links thereof are pruned, and makes inference with the input data in an inference phase.

Preferably, some neurons or some links are pruned by a neuron statistic engine.

Preferably, the neuron statistic engine is designed to compute and store activity statistics for each neuron at an application phase. Moreover, the activity statistics include a histogram, a mean, or a variance of neuron's input and/or output.

Preferably, the neuron statistic engine deactivates neurons with small output values, it replaces neurons with small output variances respectively with simple bias units, or it merges neurons with same histogram or similar histograms. Moreover, it may prune the local neural network by an aggressive pruning without verification or a defensive pruning with verification.

Preferably, the pruned neural network in the local AI device is derived by pruning an original neural network possessing model generality.

In a further aspect, the local learning system in the local AI device may have its neuron statistic engine connected to the local neural network, and including a plurality of profiles, wherein a model structure of the local neural network is decided based on a selected profile from the profiles. Moreover, the profiles imply different users, scenes, or computing resources. Furthermore, the local learning system in the local AI device includes a classification engine connected to the neuron statistic engine, and designed to classify the raw input(s) to select a suitable profile for the local neural network.

It is appreciated that, in common cases, the neural network structure (i.e. neurons and links) are fixed, and coefficients and/or biases of the neurons are unchangeable in the local AI device. However, according to the present invention, the local AI device can support a suitable neural network that can be trained by local learning, instead of a deep neural network that has to be trained by a standalone or cloud computing server with high level hardware.

Other objects, advantages, and novel features of the invention will become more apparent from the following detailed description when taken in conjunction with the accompanying drawings.

### BRIEF DESCRIPTION OF THE DRAWINGS

FIG. 1 shows a schematic diagram illustrating a prior art deep neural network architecture between a server and a local device;

FIG. 2 shows a schematic diagram of a local learning system according to one embodiment of the present invention;

FIG. 3 shows a smartphone including the local learning system according to one embodiment of the present invention;

FIG. 4 shows an original neural network for training phase and its pruned neural network for application phase according to the present invention;

FIG. 5 illustrates the details of the pruning depending on histograms of neurons by a neuron statistic engine according to one embodiment of the present invention;

FIG. 6 shows a schematic diagram of a learning system with multiple profiles for pruning or inference according to one embodiment of the present invention; and

FIG. 7 shows an example of speech recognition of smart home assistant according to the present invention.

### DETAILED DESCRIPTION OF THE PREFERRED EMBODIMENT

Different embodiments of the present invention are provided in the following detailed description. These embodiments are not meant to limiting. It is possible to make modifications, replacements, combinations, separations or designs with the features of the present invention to apply to other embodiments.

(Local Learning for Artificial Intelligence Device)

The present invention aims to realize local learning applied to local AI device(s), such as smartphone, tablet, smart-TV, telephone, computer, home entertainment, wearable device, and so on, instead of standalone or cloud computing server(s) with high level hardware.

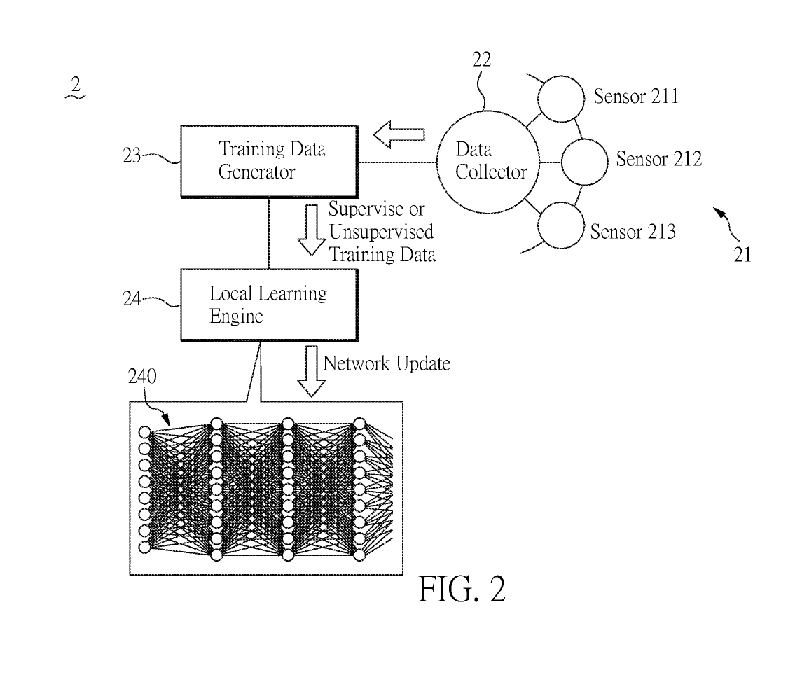

FIG. 2 shows a schematic diagram of a local learning system 2 according to one embodiment of the present invention.

The local learning system 2 includes at least one data source 21 (a plurality of sensors 211, 212, 213 are shown for example), a data collector 22, a training data generator 23, and a local leaning engine 24 with a local neural network 240.

The data collector 22, the training data generator 23, and the local leaning engine 24 may be realized as separated program modules or an integrated software program (e.g. APP) that can be executed by intrinsic hardware of a local AI device (such as a smartphone).

The data source(s) 21 may be sensors used to sense physical quantities from real-world for local learning. The sensor(s) may be of same type or different types, such as microphone, image sensor, temperature sensor, location sensor, and so on. Alternatively, the data source(s) 21 may be software database(s).

In case where the data source(s) are sensor(s), the sensed physical quantities are collected by the data collector 22, and then sent to the training data generator 23 as input data.

The training data generator 23 is used to analyze the input data to produce paired examples (e.g. labeled data) for supervised learning, or simply produce unlabeled data for unsupervised learning. Generally, in a supervised learning, each example is a pair consisting of an input and a corresponding output, and a neural network is designed to study the relation between the input and the corresponding output from each example, so as to produce an inferred function, which can be used for mapping new examples.

The local leaning engine 24 includes the local neural network 240. A learning task of the local leaning engine 24 may be performed on a single training data point or a small batch of data points. In other words, the local learning engine 24 may be designed to allow data inputting in sequence or in parallel. The local leaning engine 24 may employ an incremental leaning mechanism, that is, it updates coefficients and/or biases of neurons of the neural network 240 incrementally. Preferably, the local leaning engine 24 (and specifically, the local neural network 240) is designed in a way that the inference process (or phase) is not interrupted during the training process (or phase), especially during data inputting, or the neural network is being updated.

The training may or may not be performed during the inference. However, we may set the inference with a higher priority than that of the training, so as not to interrupt the inference, and thus avoid bad user experience.

The training and the inference can be performed at the same time if there is enough hardware resource, for example, in case where the inference only uses some groups of N groups of computing engines. In this case, the training results may be stored temporally, and to be read out to update the local neural network 240 until no inference is performing. An incremental update method may also be used to update a small portion of the neural network each time, and complete the update after several times.

Alternatively, if all hardware resource is occupied for the inference, the training can be performed whenever there is no inference performing.

Accordingly, the local learning system 2 allows an initial neural network (with suitable coefficients and/or biases in neurons) deploying to various types of local AI devices. Moreover, each individual local AI device can adapt to its environmentby local learning with the input data provided by the data sources 21.

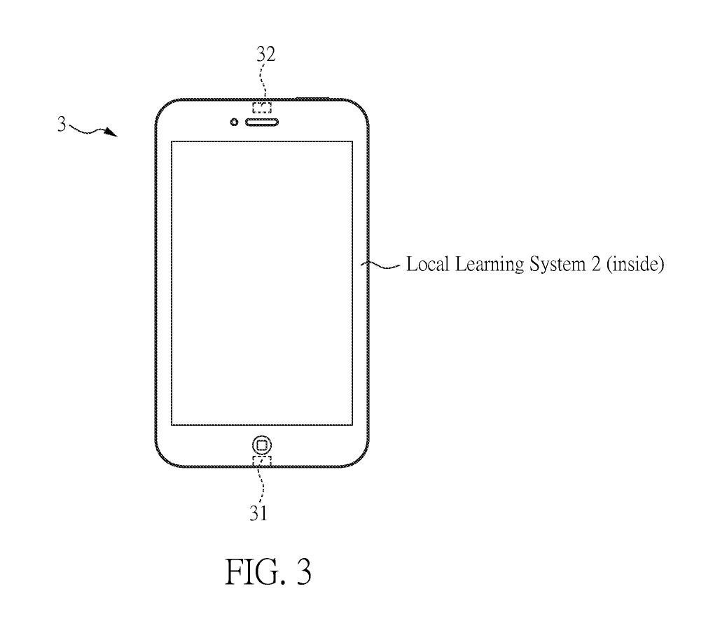

(Example of smartphone speech enhancement) FIG. 3 shows a smartphone 3 including the local learning system 2 according to one embodiment of the present invention. This section is illustrated with reference both to FIGS. 2 and 3.

In addition to the local learning system 2, the smartphone 3 further includes a primary microphone 31 and a secondary microphone 32 as the data source(s) 21 for collecting audio waveforms.

The training data generator 23 may use at least one microphone input to estimate or produce data pairs of either a clean sound or a noisy sound. A clean sound may be a human speech, and a noisy sound may be a mixture of the clean sound and an environmental noise. In particular, the training data generator 23 may receive a (relatively) clean sound input (e.g. a clean waveform) in a first time interval, and a (relatively) noisy sound input (e.g. a noisy waveform) in a second time interval later than the first time interval, both from the primary microphone 31. Alternatively, the training data generator 23 may receive a (relatively) clean sound input from the primary microphone 31, and a (relatively) noisy sound input from the secondary microphone 32 (and vice versa), simultaneously.

Then, the training data generator 23 may pair the clean waveform with a label “clean” to form a data pair (clean waveform, “clean”), and pair the noisy waveform with a label “noisy” to form another data pair (noisy waveform, “noisy”).

The generated data pairs are then sent to the local leaning engine 24. The local learning engine 24 may use stochastic gradient descent in supervised learning to update (i.e. to train) the neural network 240. The neural network 240 may be used to perform sound (e.g. speech) enhancement by identifying and further filtering out undesirable noises from the noisy sound to recover the sound as clean as possible.

(Neural Network Online Pruning)

A deep neural network learns a general mapping from source data to prediction targets by using lots of training data to train its model with lots of parameters. Because of the complexity of the model, the deep neural network has to be constructed in a standalone or cloud computing server with high level hardware.

However, the variety of data source may be limited in real world applications, which implies that the model size can be further reduced. In other words, we may pursue a “utility mapping” in a pruned (or simplified) neural network rather than the “general mapping” in the deep neural network. According to the present invention, the pruned neural network is preferably applicable to a local AI device.

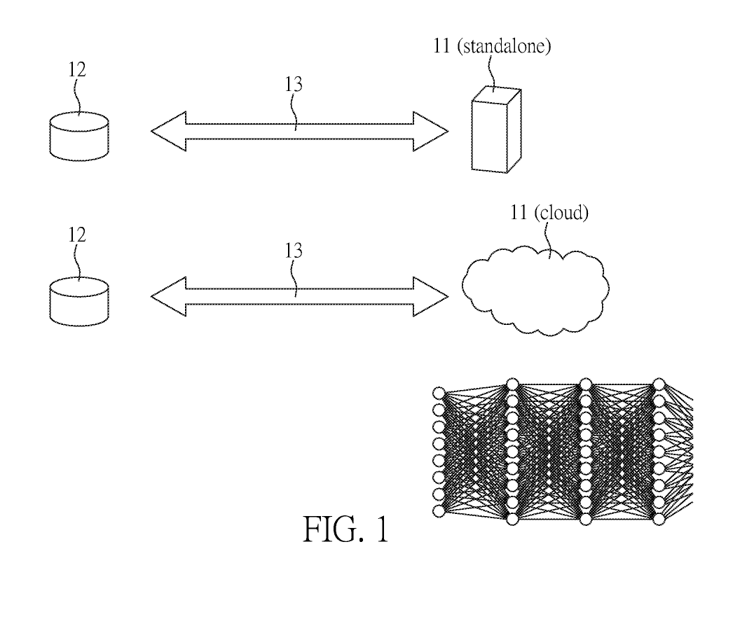

In another aspect, as shown in FIG. 1, a conventional re-train flow requires network connectivity (i.e. the network link 13) between the local device 12 and the server 11. The re-training stops when no internet is available.

In a further aspect, there may be user privacy concerns when lots of training data, such as user's photos, voices, videos, and other private data are uploaded to the server 11.

Therefore, the present invention aims to provide a local training system that can be trained independently of the server 11.

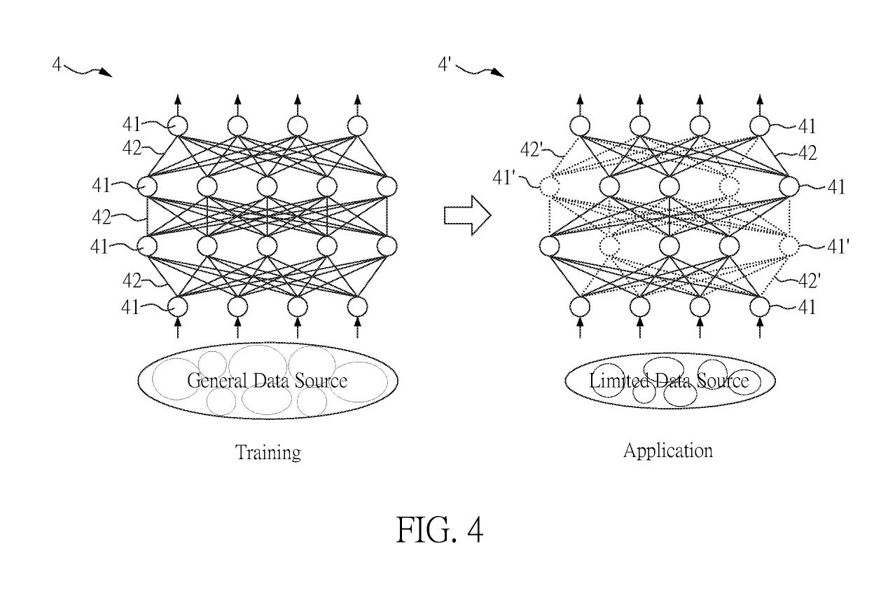

FIG. 4 shows an original neural network 4 for training phase and its pruned neural network 4′ for application phase according to the present invention. This section is illustrated with reference to FIGS. 2 to 4.

In common cases, the original neural network 4 is a deep neural network constructed in a standalone or cloud computing server. However, according to the present invention, the original neural network 4 is a local neural network provided in a local learning system 2.

The original neural network 4 includes a plurality of neurons 41 and a plurality of links 42 between the neurons 41, and it has a (relatively) complete neural network structure. In the training phase, large data source is used to train the original neural network 4, so as to enhance its model generality; which means that the model may be effective in general cases.

After the original neural network 4 obtains enough model generality in the training phase, it is pruned to become the pruned neural network 4′ for the application phase.

The term “application phase” refers to the phase that the user is using the local AI device, and may include an edge training (i.e. training the local neural network) and an edge inference (i.e. inference by the local neural network).

When performing such a pruning, we compute activity statistics for each neuron 41 of the original neural network 4, and then prune less activated neurons, or merge similar neurons for footprint reduction in terms of model size, power, or memory. As shown in the right side of FIG. 4, dash circles represent pruned neurons 41′, and dash lines represents pruned links 42′. Clearly, the pruned neural network 4′ has a simplified structure, suitable to be executed in a local AI device, such as a smartphone. The details of the pruning will be discussed later in the following description.

Then, the pruned neural network 4′ is applied to the local learning system 2, which may be included in the local AI device. The pruned neural network 4′ can be placed in the neural network 240 of the local leaning engine 24 of the local learning system 2. With the pruned neural network 4′, the local learning system 2 can perform local learning without connection to the server.

As shown in the right side of FIG. 4, the pruned neural network 4′ in the local learning system 2 is trained only by limited data source, collected in a specific environment, for example, home, office, classroom, and so on. However, even though the pruned neural network 4′ lacks some neurons or some links, it is still effective to learn and recognize objects or conditions in the specific environment, because the specific environment has less variety.

In some cases, the pruning of the original neural network 4 is performed at the server end. After the pruning, the pruned neural network 4′ is downloaded to the local learning system 2 of the local AI device, and can be trained independently of the server, and local learning is therefore realized. However, according to the present invention, the pruning of the original neural network 4 can further be performed at the local end to fit the local environment.

Herein, it should be noted that the concept of “pruning” is different from the concept of “dropout” for a neural network. The pruning is applied after the original neural network 4 obtains enough model generality in the training phase, and it is applied in the application phase, intending for footprint reduction. While, in the dropout, some neurons are temporally dropped out in the training phase to avoid overfitting, and the dropped neurons recover again in the inference phase.

(Neuron Statistic Engine)

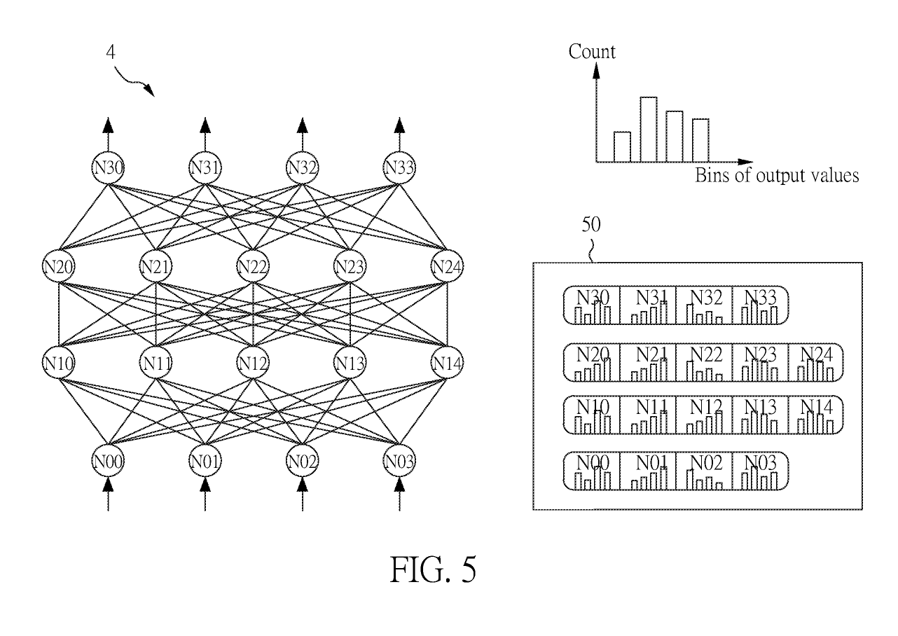

FIG. 5 illustrates the details of the pruning depending on histograms of neurons by a neuron statistic engine 50 according to one embodiment of the present invention.

A neuron statistic engine 50 is designed to determine which neuron should be pruned. In particular, the neuron statistic engine 50 is designed to compute and store activity statistics for each neuron at the application phase. The neuron statistic engine 50 may be set in the local AI device to prune the original neural network 4 therein.

The activity statistics may include a histogram of neuron's input and/or output, a mean of neuron's input and/or output, a variance of neuron's input and/or output, and other kinds of statistical quantities. A histogram is shown in the top-right side of FIG. 5, with bins of output values in X-axis and count(s) in Y-axis.

The left side of FIG. 5 shows an original neural network 4, and it has neurons N00, N01, N02, N03 in the zeroth layer L0, and neurons N10, N11, N12, N13, N14 in the first layer L1, and so on, and it has totally 18 neurons in four layers. The histograms of the neurons of the original neural network 4 are shown in the bottom-right side of FIG. 5. It is to be understood that the original neural network 4 and the histograms in FIG. 5 are only shown for illustrative purposes, and they are not limited thereto.

The activity statistics may be used for on-device pruning/merging or, alternatively, the statistical results may be transmitted to the server for model adaptation.

The neuron statistic engine 50 may perform the pruning or the merging according to any or all of the following pruning/merging criteria:

For neurons with small output values, it deactivates them in the inference phase. That is, the neurons disappear in the pruned neural network 4′.

For neurons with small output variances, it replaces them respectively with simple bias units, which means that the neurons only respectively have constants instead of variables.

For neurons with same histogram or similar histograms, it merges them to remain only one neuron active. The links connected to the pruned neuron are instead connected to the remaining neuron. For example, neurons N11 and N12 have same histogram, so one of them can be merged into the other, as correspondingly shown in FIG. 4.

In addition, the pruning may be an aggressive pruning without verification or a defensive pruning with verification.

In particular, the aggressive pruning means to directly prune the neurons that satisfy the pruning/merging criteria.

The defensive pruning does not immediately prune the neurons, and it may include the following steps:

Step T1: storing input signals and prediction (inference) results of the original neural network 4;

Step T2: pruning the original neural network 4 to become the pruned neural network 4′;

Step T3: running the pruned neural network 4′ with the stored input signals, and evaluating the gap of prediction results between original neural network 4 and pruned neural network 4′; and

Step T4: deciding whether or not to prune based on a pre-defined threshold. For example, if the gap of prediction results between the original neural network 4 and pruned neural network 4′ is greater than the pre-defined threshold, the pruning may be aborted. The pre-defined threshold may be given case by case in practical application.

(Multiple Profiles for Pruning or Inference)

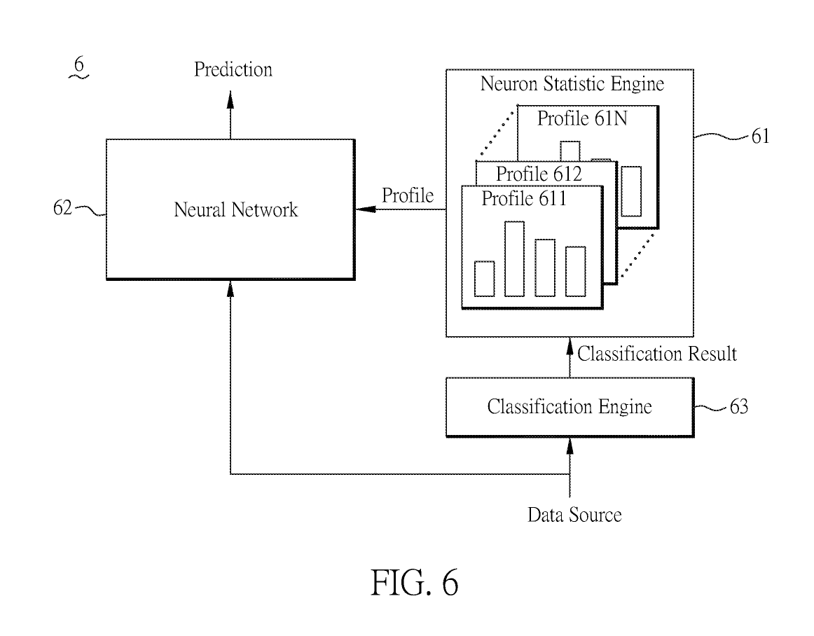

FIG. 6 shows a schematic diagram of a learning system 6 with multiple profiles for pruning or inference according to one embodiment of the present invention.

The learning system 6 includes a neuron statistic engine 61, a neural network 62, and a classification engine 63.

The neuron statistic engine 61 includes a plurality of profiles 611, 612, . . . , 61N, for example. The profiles support different pruning or inference conditions for the neural network 62. For example, the profiles may imply different users, scenes, or computing resources.

The neural network 62 may receive raw input(s) and make a prediction based on the raw input(s). The neural network 62 is connected to the neuron statistic engine 61. The pruning or the inference of the neural network 62 may be decided by one profile, for example, the profile 611 selected from the neuron statistic engine 61. In other words, the model structure of the local neural network 62 is decided based on a selected profile. The profile may be selected automatically or manually.

For example, when a local AI device (such as a smartphone) is in a low battery mode, a computing resource profile is automatically applied to the neural network 62 of the local AI device, and lets the neural network 62 be further pruned to have a minimized structure. With the reduced calculation complexity, the neural network 62 can consume less power in the low battery mode.

The classification engine 63 is connected to the neuron statistic engine 61, and it is designed to classify the raw input(s) to select a suitable profile 61N for the neural network 62.

(Example of Speech Recognition of Smart Home Assistant)

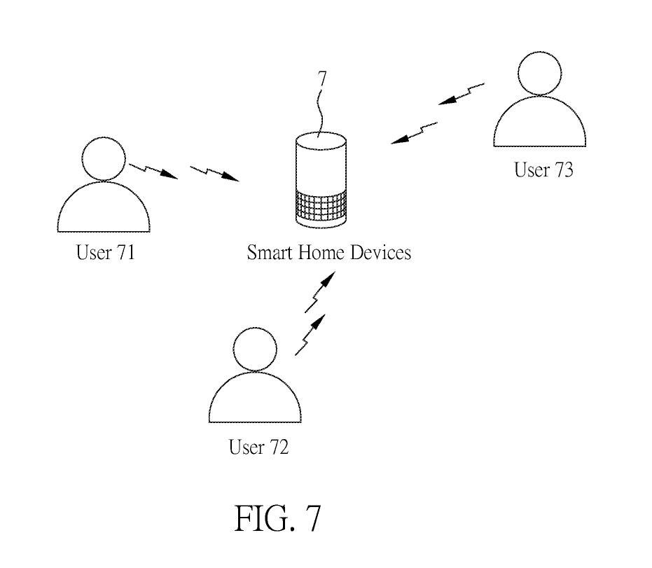

FIG. 7 shows an example of speech recognition of smart home assistant according to the present invention. This section is illustrated with reference both to FIGS. 4 and 7.

In common cases, the original neural network 4 is trained by using large corpus for all possible words, phonemes, and accents, so as to realize a robust model.

However, in a real use case, there may be only limited users living in a specific environment. For example, as shown in FIG. 7, a smart home device (e.g. a smart home assistant) 7 serves only three users 71, 72, 73 living in a house. The smart home device 7 is controlled by voice commands, so it has a speech recognition function implemented by the pruned neural network 4′.

The pruned neural network 4′ of the smart home device 7 only has to learn and recognize the words, the phonemes, and/or the accents from the three users 71, 72, 73 living in the house, and remains effective even though it is pruned.

The smart home device 7 can be trained without connection to a server. Besides, the voice or the speech of the user(s) does not have to upload to a server, and the user(s) can keep their privacies from being exposed.

In conclusion, the present invention provides a local learning system that can be executed in a local AI device, which can be trained without connection to a computing server. Moreover, the present invention introduces a pruning method to reduce the complexity of neural network, allowing a pruned neural network executable by the local AI device.

Although the present invention has been explained in relation to its preferred embodiment, it is to be understood that many other possible modifications and variations can be made without departing from the spirit and scope of the invention as hereinafter claimed.

What is claimed is:

1. A local learning system in a local artificial intelligence (AI) device, comprising:
at least one data source;
a data collector connected to the at least one data source, and used to collect input data;
a training data generator connected to the data collector, and used to analyze the input data to produce paired examples for supervised learning, or unlabeled data for unsupervised learning; and
a local leaning engine connected to the training data generator, and including a local neural network, wherein the local neural network is trained by the paired examples or the unlabeled data in a training phase, and makes inference in an inference phase.

2. The local learning system in the local AI device as claimed in claim 1, wherein the local learning system is trained in the local AI device without connection to a standalone or cloud computing server with high level hardware.

3. The local learning system in the local AI device as claimed in claim 1, wherein the local leaning engine allows inputting a single training data point in sequence or a small batch of data points in parallel.

4. The local learning system in the local AI device as claimed in claim 1, wherein the local leaning engine employs an incremental leaning mechanism.

5. The local learning system in the local AI device as claimed in claim 1, wherein the local leaning engine is designed in a way that the inference phase is not interrupted during the training phase.

6. The local learning system in the local AI device as claimed in claim 1, wherein the local AI device is a smartphone, the at least one data source includes a primary microphone and a secondary microphone, and the training data generator produces data pairs from at least one of the primary microphone or the secondary microphone.

7. The local learning system in the local AI device as claimed in claim 6, wherein the data pairs imply a clean sound and a noisy sound.

8. The local learning system in the local AI device as claimed in claim 7, wherein the local leaning engine is trained by stochastic gradient descent with the data pairs, so as to perform sound enhancement by identifying and further filtering out the noise from the noisy sound.

9. A local learning system in a local artificial intelligence AI) device, comprising:
at least one data source;
a data collector connected to the at least one data source, and used to collect input data;
a data generator connected to the data collector, and used to analyze the input data; and
a local engine connected to the data generator, and including a local neural network, wherein the local neural network is a pruned neural network that some neurons or some links thereof are pruned by a neuron statistic engine, and makes inference with the input data in an inference phase.

10. The local learning system in the local AI device as claimed in claim 9, wherein the neuron statistic engine is designed to compute and store activity statistics for each neuron at an application phase.

11. The local learning system in the local AI device as claimed in claim 10, wherein the activity statistics include a histogram, a mean, or a variance of neuron's input and/or output.

12. The local learning system in the local AI device as claimed in claim 9, wherein the neuron statistic engine deactivates neurons with small output values.

13. The local learning system in the local AI device as claimed in claim 9, wherein the neuron statistic engine replaces neurons with small output variances respectively with simple bias units.

14. The local learning system in the local AI device as claimed in claim 9, wherein the neuron statistic engine merges neurons with same histogram or similar histograms.

15. The local learning system in the local AI device as claimed in claim 9, wherein the neuron statistic engine prunes the local neural network by an aggressive pruning without verification or a defensive pruning with verification.

16. The local learning system in the local AI device as claimed in claim 9, wherein the pruned neural network in the local AI device is derived by pruning an original neural network possessing model generality.

17. The local learning system in the local AI device as claimed in claim 9, wherein the neuron statistic engine is connected to the local neural network, and includes a plurality of profiles, wherein a model structure of the local neural network is decided based on a selected profile from the profiles.

18. The local learning system in the local AI device as claimed in claim 17, wherein the profiles imply different users, scenes, or computing resources.

19. The local learning system in the local AI device as claimed in claim 17, further comprising a classification engine connected to the neuron statistic engine, and designed to classify the raw input(s) to select a suitable profile for the local neural network.
